(19) United States
(12) Patent Application Publication
(10) Pub. No.: US 2026/0097481 A1
(43) Pub. Date: Apr. 9, 2026

(54) TOOL FOR OPENING MEDICAL DEVICE

(71) Applicant: Elite Biomedical Solutions, LLC, Cincinnati, OH (US)

(72) Inventors: Mitchell CLINE, Cincinnati, OH (US); Daniel MEISER, Cincinnati, OH (US)

(73) Assignee: Elite Biomedical Solutions, LLC, Cincinnati, OH (US)

(21) Appl. No.: 18/908,900

(22) Filed: Oct. 8, 2024

(51) Int. Cl. B25J 1/12

(52) U.S. Cl. CPC B25J 1/12

(57) ABSTRACT

A tool for opening a medical device comprising a base support; a bottom support attached to the base support; a top support attached to the base support; a fixed hook subassembly attached to the base support; a movable hook subassembly; and a toggle clamp subassembly attached to the base support, wherein the movable hook subassembly is attached to the toggle clamp subassembly. A method of opening a medical device wherein the tool is employed to open the device.

### BACKGROUND OF THE INVENTION

In a hospital setting, medical personnel use various pieces of equipment, some of which are electronic device, such as thermometers, blood pressure cuffs and telemetry devices. Many of these devices are expensive and are purchased by medical facilities to last for many years. During the years of use, some of these devices are worn by patients in the hospital and can become damaged or worn out and need parts replaced. Entry into the interior of these types of devices can prove difficult when the outer most pieces are snapped together rather than held together with fasteners, such a screws. Further, opening snap together pieces of a medical device could damage internal components when opening the device. Therefore, it is critical to develop ways to fix or replace portions of the device without damaging other components.

One such telemetry device is the Philips Intellivue MX40 wearable patient monitor. This unit helps a patient remain mobile while still having vital biological information transmitted and monitored by the medical personnel. Biological information of the patient monitored by this device includes an electrocardiogram (ECG), heart rate (HR), pulse, respiration, and blood pressure, among others. This biological information is gathered or transmitted by electrodes attached to the patient that are then plugged into or attached to the wearable device. This device is considered wireless in that it is run on a battery and does not need to be plugged into a direct power source such an electrical outlet. Being wireless provides mobility to the patient to move about the hospital to other units or to perform physical activities, such as recovery exercises, physical therapy or general exercise.

A monitor such as the MX40 is held together when a front case portion is snapped into a back case portion. Other components such electronic parts, a screen and battery may be contained inside these two case portions. That is, the front case and rear case are held together with numerous snap tabs on an internal frame. This internal frame mates with recessed pockets in the rear case and also fastens to the front case in the same manner. Unsnapping these case portions can be difficult and lead to damaging other parts of the device when disassembling the device.

Often times, these types of devices may have openings in either the front case or rear case near the snap tabs. These opening appear to allow some tool to be inserted to disengage the snap tabs and disassemble the front case from the rear case. However, the manufacturers do not provide any tool or tools for opening the case of the unit. Rather, a purchaser or user would need to send the device back to the manufacturer to repair the device. This can cost the purchaser time and money to have the device opened and repaired by the manufacturer or risk damaging the device when the purchaser attempts to open it.

Therefore, there is a need to develop a simple opening tool for disassembling a medical device for repair. Such a tool would allow the purchaser, user or third party repair person to open the device safely, efficiently and effectively with no damage to other components of the device in order to make the necessary repairs to the device for continued use. The tool described herein is one such device.

### SUMMARY OF THE INVENTION

The inventors have developed an opening tool for medical devices, such as a wearable telemetry monitor, that can disassemble the outer case without damaging the device or other components within the device. This tool comprises a base support; a bottom support attached to the base support; a top support attached to the base support; a fixed hook subassembly attached to the base support; a movable hook subassembly; and a toggle clamp subassembly attached to the base support, wherein the movable hook subassembly is attached to the toggle clamp subassembly. The fixed hook subassembly can be inserted in first opening on one side of either the front or rear case while the movable hook assembly can be inserted in a second opening on a side opposite of the first opening. Once the fixed hook subassembly and the movable hook subassembly are inserted, the toggle clamp subassembly is engaged to pull the sides of a case in opposite directions thereby widening the case sides to disengage the snap tabs. The front case and rear case can then be separated or disassembled to access the internal components of the device without damaging any of the other components.

The details of this tool and each component of the tool are discussed in greater detail below.

### BRIEF DESCRIPTION OF DRAWINGS

FIG. 1 is a schematic of the tool showing all parts and attachment meanings.

FIG. 2 is a top down view of the tool.

FIG. 3 is a bottom view of the tool.

FIG. 4 is a side view of the tool.

FIG. 5 is a side view of the tool showing a measurement between the hooks.

FIG. 6 is a top down view with the calibration tool in place.

FIG. 7 is a side view with the calibration tool in place.

FIG. 8 is a side view of the MX40 medical device.

FIG. 9 is an internal view of the MX40 showing the internal frame as well as the snap tabs, recessed pockets and access hole or opening.

FIG. 10 is a depiction of the assembled tool from above.

FIG. 11 is a bottom view of the assembled tool.

FIG. 12A is a close up view of the movable hook subassembly attached to the toggle clamp.

FIG. 12B is a second close up view of the movable hook subassembly attached to the toggle clamp.

FIG. 13 is a close up view of the fixed hook subassembly.

FIG. 14 is a close up view of the fixed hook subassembly with the hook detached.

FIG. 15 is a close up view of the fixed hook entering the MX40 medical device.

FIG. 16 is a view of the MX40 attached to the fixed hook and resting on the top support, bottom support and base support.

FIG. 17 is a view of the movable hook entering the second opening on the MX40 medical device.

FIG. 18 is a view of the movable hook attached to the second opening on the MX40 medical device.

FIG. 19 is a depiction of the toggle bar being engaged to expand the rear case of the MX40 medical device.

FIG. 20 is a depiction of the toggle bar fully engaged or clamped down to expand the rear case of the MX40 medical device.

FIG. 21 is a close view of the sides of the rear case where the hooks have expanded the rear case sides.

FIG. 22 is a depiction of the front case bring removed from the rear case.

FIG. 23 is a depiction of the rear case with the front case removed and the hooks still engaged expanding the sides of the rear case.

### DETAILED DESCRIPTION OF THE INVENTION

Specific embodiments of the invention are described herein. The invention can, however, be embodied in different forms and should not be construed as limited to the embodiments set forth herein. Rather, these embodiments are provided to illustrate more specific features of certain embodiments of the invention to those skilled in the art.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive of additional elements or steps, in a manner similar to the term “comprising” as that term is interpreted when employed as a transitional word in a claim. Furthermore, to the extent that the term “or” is employed (e.g., A or B), it is intended to mean “A or B or both.” When the “only A or B but not both” is intended, then the term “only A or B but not both” is employed. Thus, use of the term “or” herein is the inclusive, and not the exclusive use. When the term “and” as well as “or” are used together, as in “A and/or B” this indicates A or B as well as A and B.

All ranges and parameters, including but not limited to percentages, concentrations, temperatures, parts, ratios and other numerical parameters disclosed herein are understood to encompass any and all sub-ranges subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein can be performed in any order, unless otherwise specified or clearly implied to the contrary by the context in which the referenced combination is made.

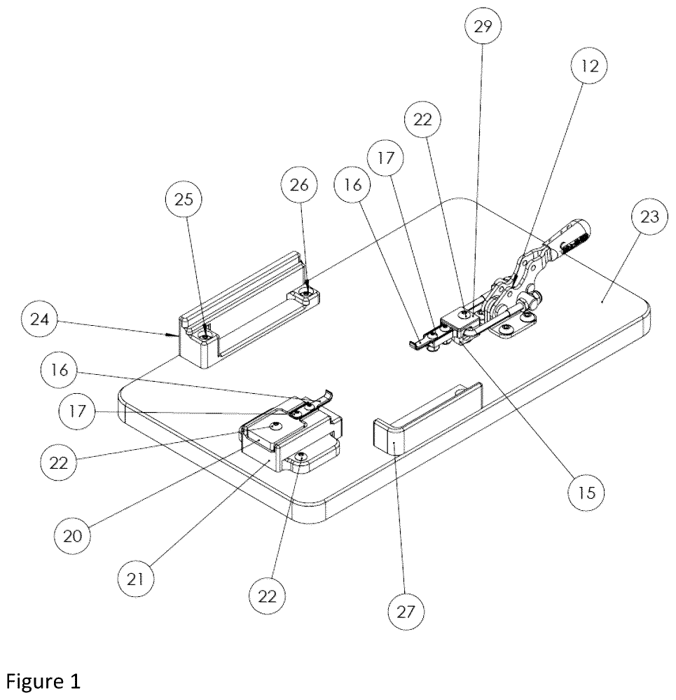

As noted above and as shown in FIG. 1, the tool for opening medical devices comprises a base support (23); a top support (27) attached to the top of the base support; a bottom support (24) attached to the top of the base support; a fixed hook subassembly attached to the top of the base support; a movable hook subassembly; and a toggle clamp subassembly (12) attached to the top of the base support, wherein the movable hook subassembly is attached to the toggle clamp subassembly. These components are arranged in such a manner to hold the medical device so that the device can be disassembled. That is, the specific arrangement of these parts will be specific for the medical device to be opened or repaired.

The base support (23) is a solid material to which the other components can be attached or fastened. The base support material may be wood, metal, a polymer material, or a plastic material. The metal may be any metal that maintains its shape when in use, including aluminum, steel, stainless steel, titanium, tungsten, brass, copper, and zinc. The plastic may be any plastic suitable for maintain its shape and durability during use, including thermoplastics, homopolymer acetal resin (Delrin 150®), polyethylene, high density polyethylene or ultra-high-molecular-weight polyethylene, acrylonitrile butadiene styrene (ABS), polyvinyl chloride (PVC). The base support can be any shape or size suitable for the components to be attached and open the desired medical device. The base support may be about 12 inches long by about 8 inches wide and about 0.25 inches to about 2 inches in height, preferably about 10.5 inches long by about 6 inches wide by about 0.5 inches in height.

The base support will have two surfaces, the top surface and the bottom surface. As mentioned above, the bottom support, the top support, the fixed hook subassembly and the toggle clamp are all attached or fastened to the top surface of the base support. The bottom surface may include bumpers, supports or feet. The bumpers, supports or feet are included to stabilize the base support and reduce slippage during use. The bumpers, supports or feet may be fixed or adjustable. The bumpers, supports or feet may be a non-slip material, such as rubber. One example of bumpers, supports or feet may be a compressible stem push in bumper comprising rubber.

The base support may have openings or holes which may include recessed portions around the openings or holes throughout the base support. These opening or holes may be formed when producing the base support or pre-drilled into the base support prior to assembling the components on the base support. In some embodiments, the opening or holes are smaller in diameter than the screws that will be used as fasteners to hold or attach the components to the base support. In other embodiments, the openings or holes are large enough to allow the screw or bolt to pass through the hole to join with a nut or locking nut on the opposite side to attach a component to the base support. In such an instance, the hole may have a recessed portion to recess the nut or locking nut such that the nut is even with the surface or recessed below the surface of the base support. This is shown in FIG. 11. In other embodiments, the base support may have no holes or opening and may be one solid piece. In such an embodiment, the components may be attached to the base support with an adhesive or adhesive tape.

The tool also includes a top support (27) attached to the base support. This top support may be composed of a material similar to the base support described above. Preferably, the material of top support may be a polymer or plastic, including those suitable for the base support. More preferably the top support is composed of a homopolymer acetal resin. The top support is molded or shaped to support, cradle or hold a first portion of the medical device to be opened. That is, the shape of the top support will hold the first portion of the medical device on at least one side so that the medical device will not move during use and is positioned correctly for opening. In other words, the shape of the top support may include a pocket in the same or similar shape as the first portion of the medical device in which the first portion of the medical device sits. For example, the top support will hold or cradle a first surface of medical device. In other embodiments the top support may simply support the medical device at the desired location or position for opening.

Similarly, the tool includes a bottom support (24) attached to the base support. This bottom support may be composed of a material similar to the base support. Preferably, the material of bottom support may be a plastic, including those suitable for the base support. More preferably the bottom support is composed of a homopolymer acetal resin. The bottom support is molded or shaped to support, cradle or hold a second portion of the medical device to be opened. That is, the shape of the bottom support will hold the second portion of the medical device on at least one side so that the medical device will not move during use and is positioned correctly for opening. In other words, the shape of the bottom support includes a pocket in the same or similar shape as the second portion of the medical device in which the second portion of the medical device sits. For example, the bottom support will hold or cradle a second surface of medical device. In other embodiments the bottom support may simply support the medical device at the desired location or position for opening.

The top support and bottom support are positioned on the base support in a manner to support, hold or cradle the first and second portions of the medical device. These first and second portions may be a first surface and a second surface of the device. The first and second portions may be opposite sides of the back case of the medical device. The first and second portions may be opposite side of the top case of the medical device. The portion held by the top and bottom supports depends upon the device being used. The top support and bottom support can be positioned on the base support parallel to each other. The top support and bottom support may positioned a distance apart to allow the medical device to fit securely between the top support and bottom support. The distance between the top support and bottom support may be about 5 inches to 6 inches, preferably about 5.5 to about 5.6 inches, more preferably about 5.56 inches. Again, the distance between these two parts will depend upon the device to be repaired or opened.

The portion held by the top and bottom supports will be that part of the medical device that may be stretched or pulled in opposite directions in order for the snap tabs to be released. For example, the top and bottom supports would hold or cradle the bottom case of the Philips Intellivue MX40 medical device. Again, the portion or part held by the top and bottom supports will depend on the device being used or opened.

The top support and bottom support are attached or fastened to the base support with a fastening means. The fastening means can be any material, device, mechanical means, or substance that could maintain the top and bottom supports in their desired positions. The fastening means may include rivets, screws, screws with nuts or locking nuts, an adhesive, or an adhesive tape. It is noted that the screws and/or nuts used in this tool may be a polymeric, plastic as described above for the base support, or a metal such as aluminum, steel, stainless steel, titanium, tungsten, brass, copper, and zinc. The mechanical means could be achieved using tongue and groove features between top/bottom support and base. It could also be achieved using dovetail features between top/bottom support and base. The fastening means for the top support may be the same or different than the fastening means for the bottom support.

The tool also includes a fixed hook subassembly attached to the base support. The fixed hook subassembly can include a hook, a stationary hook holder, and a stationary hook holder nest or platform. The hook and stationary hook holder may be metal, polymer material or plastic material as described for the base support. Preferably, the hook and stationary hook holder are made of a metal wherein the metal may be aluminum, steel, stainless steel, titanium, tungsten, brass, copper, and zinc. The stationary hook holder nest or platform may be a polymer material or plastic material as described above for the base support. Preferably, the stationary hook holder nest or platform is a polymer material or plastic material as described above. More preferably, the stationary hook holder nest or platform is a homopolymer acetal resin, such as Delrin 150®.

The hook and hook holder are attached to the stationary hook holder nest or platform with a fastening means, as described above for the top and bottom support. Preferably, the hook and hook holder are attached or fastened to the stationary hook holder nest or platform with one or more screws. The fixed hook subassembly (the stationary hook holder nest or platform with the hook and hook holder attached to it) is attached or fastened to the base support by any suitable fastening means, as described above. Preferably, the fixed hook subassembly is attached to the base support by one more screws or screws and nuts. More preferably, the fixed hook subassembly is attached to the base support with at least two screws or screws and nuts or four screws or screws and nuts.

The tool also includes a movable hook subassembly. The movable hook subassembly may include a hook, a hook holder and a hook holder cap. The hook is positioned on top of the hook holder. The hook holder cap is then position on top of the hook and hook holder. The hook, hook holder and hook holder cap may be made of a metal wherein the metal may be aluminum, steel, stainless steel, titanium, tungsten, brass, copper, and zinc. The hook, hook holder and hook holder cap at attached or held together by a fastening means as described herein. Preferably, the hook is attached to the hook holder by one or more screws and the hook holder cap is attached to the hook holder by at least one screw. The hook holder and hook holder cap form an opening opposite the hook. This opening acts as a clamp when attached to the toggle clamp. This allows the movable hook subassembly to be positioned on the toggle clamp as described below.

The hooks of the fixed hook subassembly and the movable hook sub assembly may the length and height necessary to be used with the desired medical device. The hooks may be 1 to 3 inches in length and have a bent hook portion at one end that is 0.25 to 0.75 inches in height. The hook may also have one or two holes through which a fastening means can be employed to attach the hook to the hook holder, which may have corresponding openings for the fastening means.

The tool may also include a toggle clamp subassembly attached to the base support. The toggle clamp is attached or fastened to the base support by any suitable fastening means, as described above. Preferably, the toggle clamp is attached to the base support by one more screws or screws and nuts. More preferably, the toggle clamp is attached to the base support with at least two screws or screws and nuts, or four screws or screws and nuts.

The toggle clamp includes a toggle bar that can move around an axle or fulcrum. The toggle clamp also includes a U shaped bar that is treaded on both ends. The U shaped bar is attached to the toggle clamp by placing the U shaped bar through openings in a holder bar that is perpendicular to the toggle bar. The openings on the holder bar are on either side of the toggle bar. the threaded ends of the U shaped bar are secured to the holder bar with at least two screws on each end of the U shaped bar. One screw may be threaded onto one end of the U shaped bar prior to insertion into a holder bar opening. The second screw will secure the U shaped bar to the holder bar once inserted. This is done on both ends of the U shaped bar.

The U shaped bar provides for an adjustable portion on the toggle clamp. In addition, the movable hook subassembly can be attached to the U shaped bar in various positions around the u shaped bar. This can be seen in FIG. 1. Therefore, the movable hook subassembly is movable and adjustable around the U shaped bar. Further, the U shaped bar may be adjust to be a longer or shorter distance away from the toggle bar. This type of adjustment allows for the hook of the movable hook subassembly to also be adjusted to be a longer or shorter distance away from the toggle bar in one respect and a longer or shorter distance away from the fixed hook subassembly. This is accomplished by moving the two screws on each end of the U shaped bar around the holder bar.

More specifically, the distance between the tips of the two hooks when the toggle clamp is locked in use is precisely set for the medical device being opened. This dimension must be set precisely to spread the case wide enough to disengage from internal frame without overstressing or damaging the case. This distance is precisely set to a pre-determined dimension by positioning the U shaped bar with respect to the U shaped bar pivot by turning the lock nuts on each side of U shaped bar to the correct location on the threaded ends of the U shaped bar. A secondary nut is then tightened on each side to help keep the U shaped bar in position.

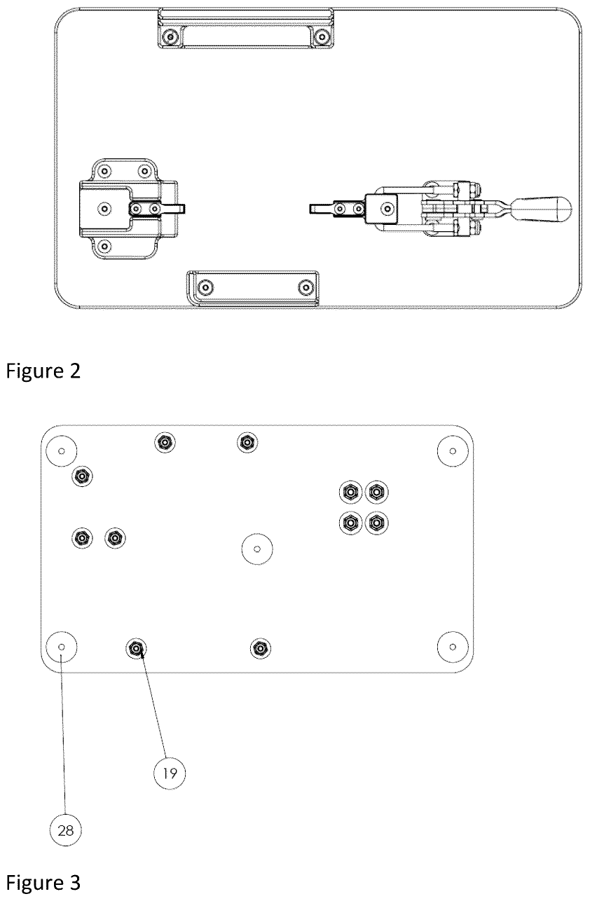

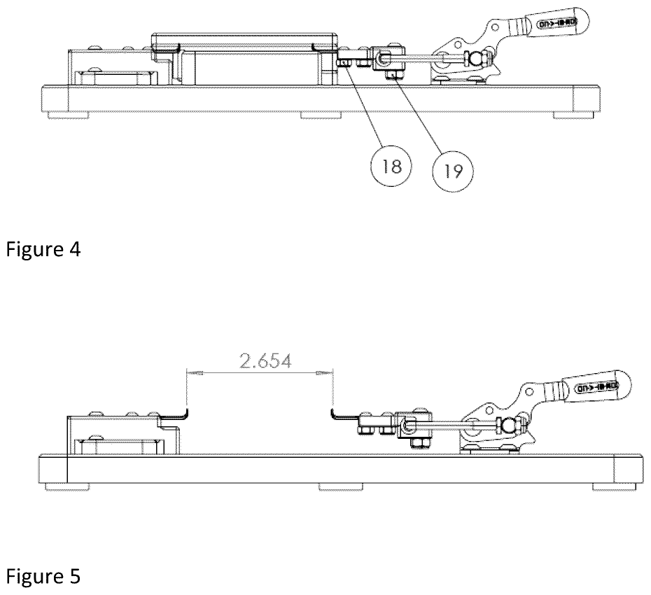

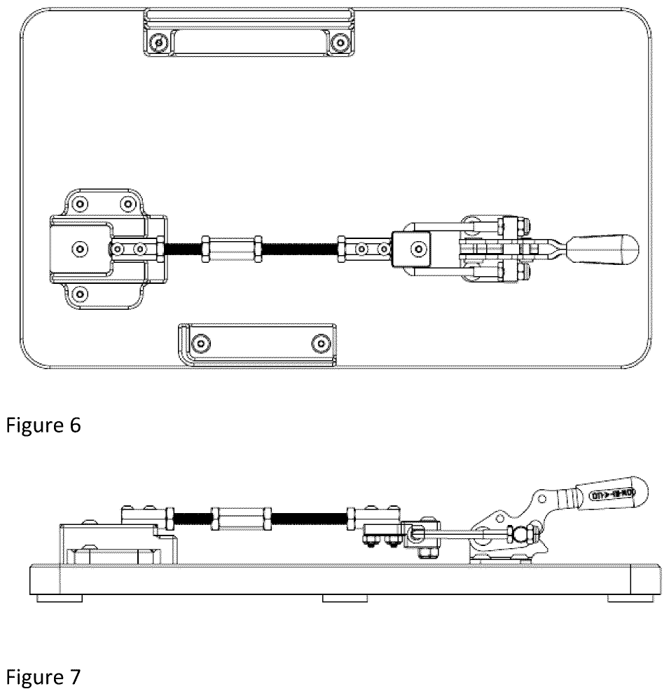

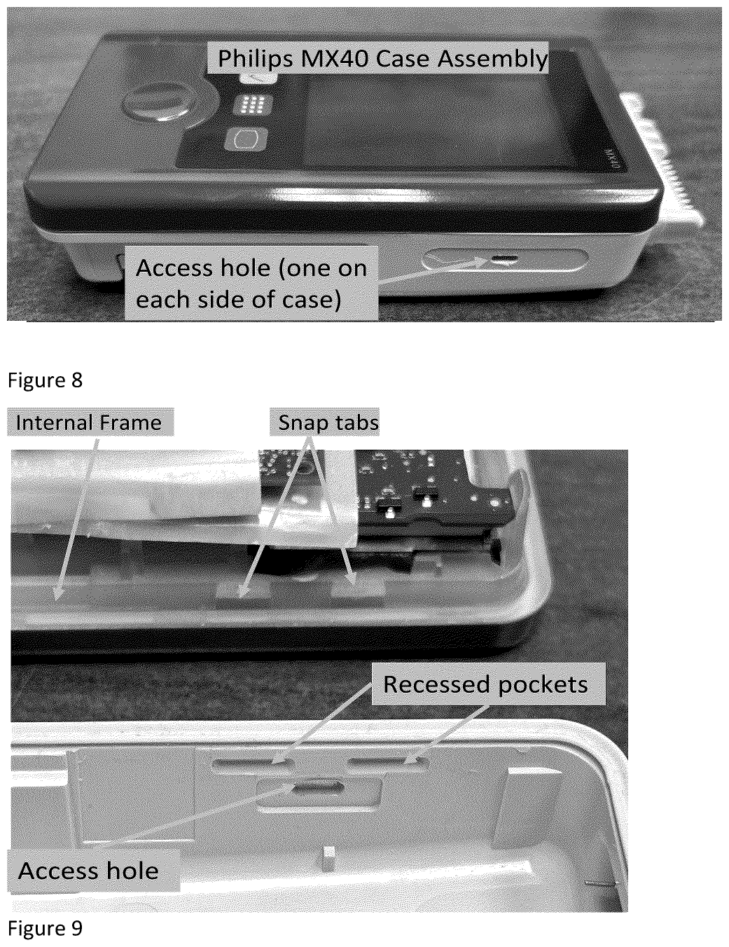

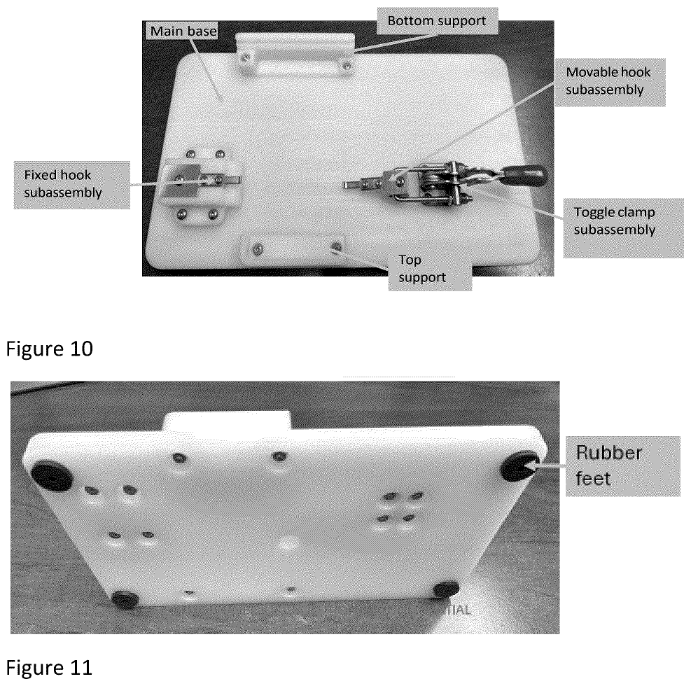

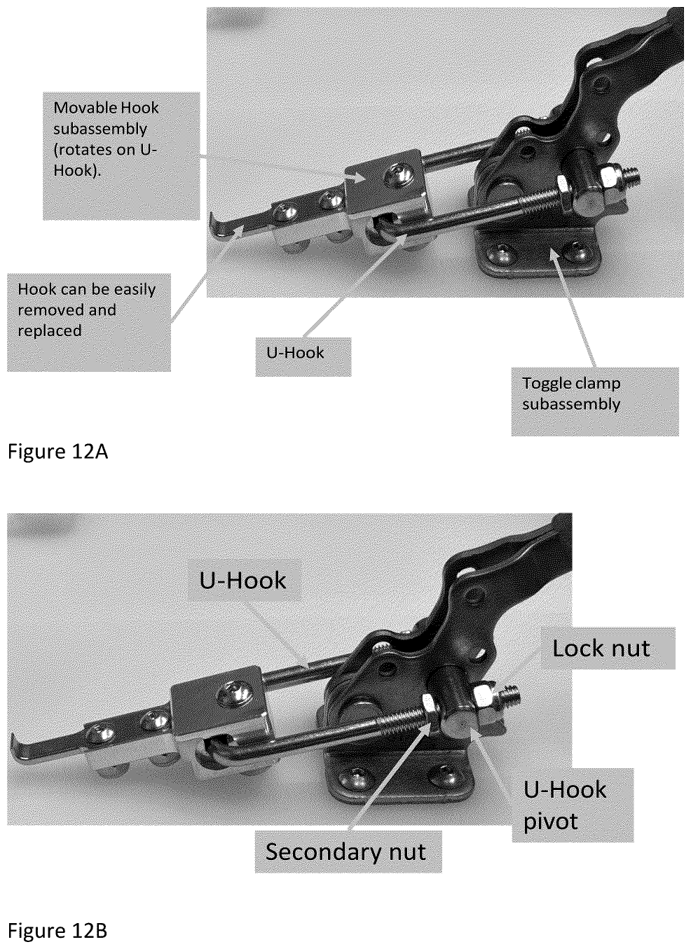

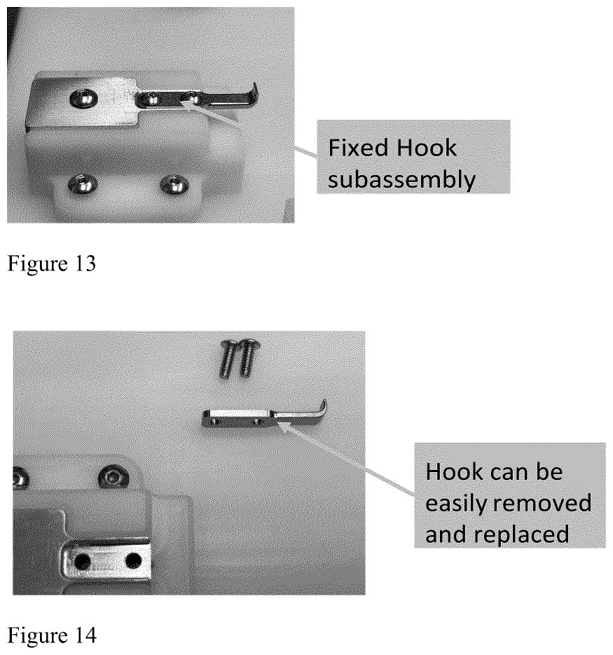

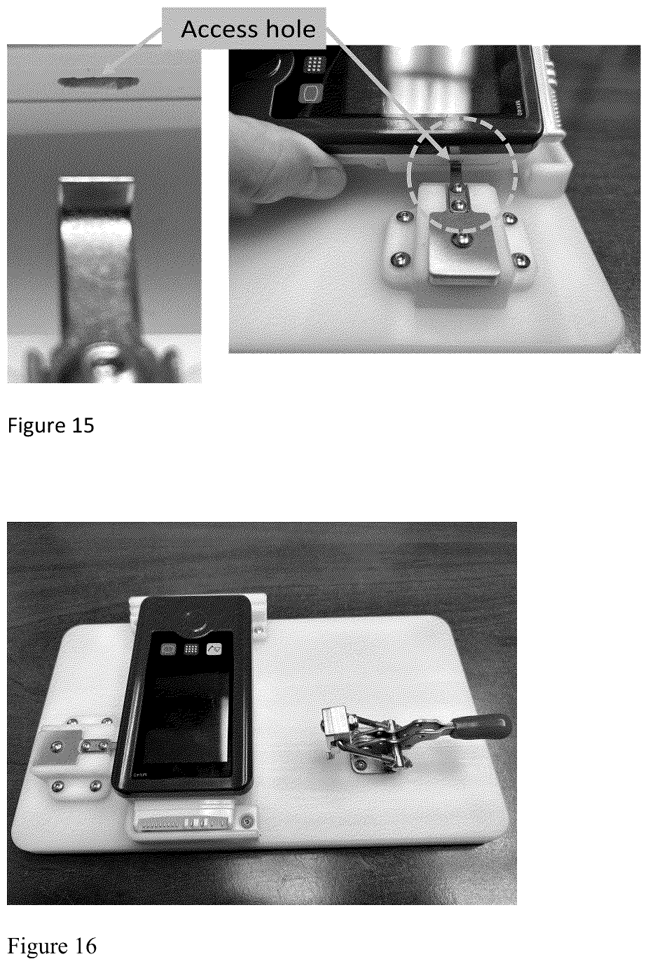

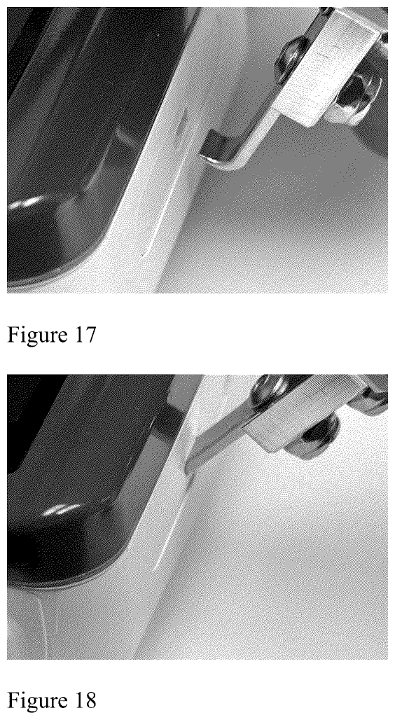

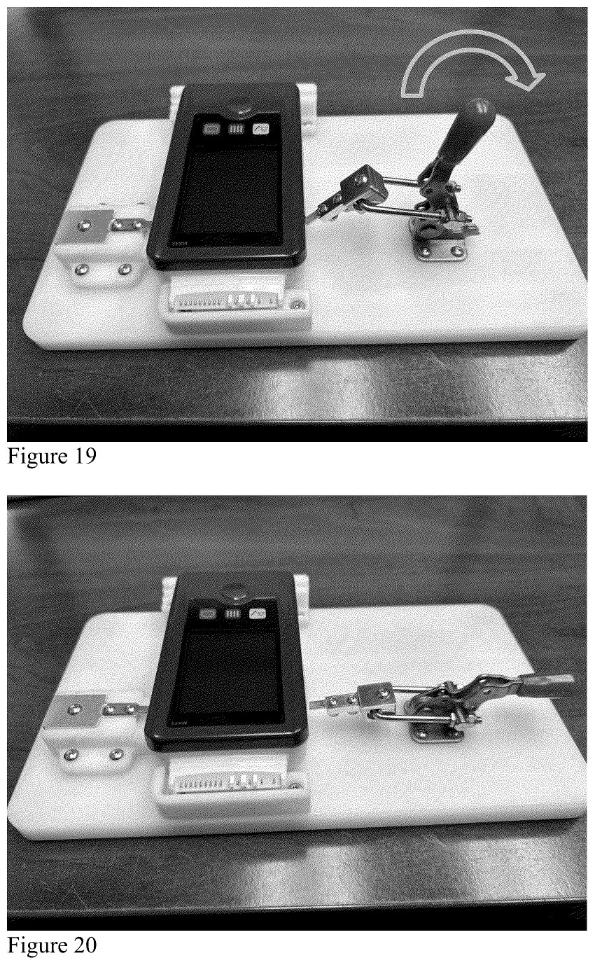

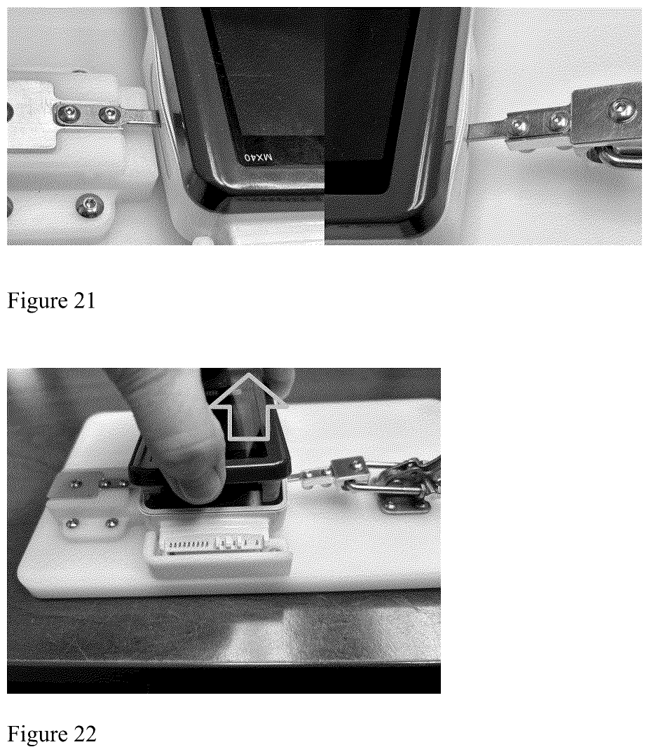

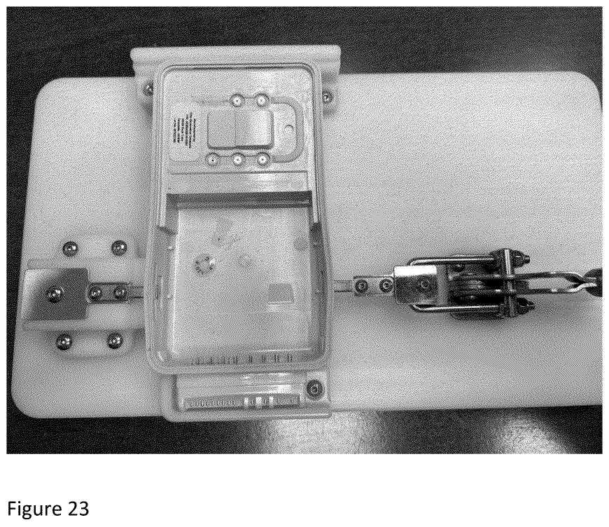

When attached to the toggle clamp, the movable hook subassembly is positioned such that the hook of the movable hook subassembly is facing the hook in the fixable hook subassembly. Depending upon the device, the hooks may be both facing up or both facing down, or one facing up and one facing down, or one hook sideways while the other hook is facing up or down. The fixed hook subassembly may mirror the movable hook subassembly. This can be seen in FIG. 1 where the hooks are arrange in the same linear or planar position. The position of the hooks will depend again on the medical device being used or opened. In some embodiments, the hooks are aligned. In other embodiments, the hooks are not in the same linear plane. Rather, the hooks will be in a position that aligns with the openings in the medical device to be used. This is shown in FIGS. 2 and 5.

Further, to ensure the precise position of the hooks for the medical device, a calibration device maybe used. When being calibrated, the calibration device is positioned between the hook holder of the fixed hook subassembly and the hook holder of the movable hook subassembly. That is, the calibration device is used without the hooks being attached to the respective hook holder. The distance between the two hooks when full assembly may be about 2 inches to about 3 inches, preferably, about 2.5 inches to about 2.75 inches, more preferably about 2.65 inches to about 2.7 inches, even more preferably 2.654 inches. This distance may be adjusted for the particular device being used.

In some embodiments, the hook in the fixed hook subassembly is identical to the hook in the movable hook subassembly. These hooks are made of a high strength steel and are shaped such that they can easily be placed in access hole without causing damage to the internal components or rear case of the medical device. In other embodiments, the hooks may be different shapes and/or sizes. The shape and size of the hooks will depend on the desired medical device being used or repaired.

The device described above when full assembly may be used to separate a top case from a bottom case to allow access to the interior of the medical device. In such a method, the medical device may be opened with the steps set forth below.
1. Align a first access hole on a first side of the rear case with the fixed hook so that the tip of the hook enters the first access hole.
2. Allow the device to rest on the bottom support, top support and base support.
3. Position the toggle clamp and movable hook subassembly so that the tip of the hook enters the second access hole on an opposite side the rear case.
4. Rotate the toggle bar of the toggle clamp towards the main base and away from the device until it locks in place.
5. The action from step 4 places the tips of the two hooks at the correct distance to spread the rear case into position to disengage the recessed pockets of the rear case from the snap tabs of the internal frame. The front case can then be easily removed without causing damage to the case components.

The device interior can then be accessed to replace parts or repair damaged parts. Once repaired, the device may reassembled. To reassemble the device the front case may be placed over the rear cases to align the snap tabs. Then the reassembly can be completed by following the steps in reverse order. Once the hooks are removed, the front case and the rear case can be snapped back together by allowing the snap tabs to be engaged with recessed pockets of the rear case and the internal frame. The device is now functional and may be put back to use in the medical facility.

The specific embodiments and examples described herein are exemplary only and are not limiting to the invention defined in the claims. Additionally, while the present invention has been illustrated by the description of embodiments thereof, and while the embodiments have been described in considerable detail, such descriptions are not intended to restrict or in any way limit the scope of the appended claims to such detail. Additional advantages and modifications will readily appear to those skilled in the art. Therefore, the invention, in its broader aspects, is not limited to the specific details, the representative compositions and processes, or illustrative examples shown and described. Accordingly, departures may be made from such details without departing from the spirit or scope of the general inventive concept.

1. A tool for opening a medical device comprising:
(a) a base support;
(b) a bottom support attached to the base support;
(c) a top support attached to the base support;
(d) a fixed hook subassembly attached to the base support;
(e) a movable hook subassembly; and
(f) a toggle clamp subassembly attached to the base support,
wherein the fixed hook subassembly is attached to the toggle clamp subassembly.

2. The tool of claim 1, wherein the base support is a wood, metal, a polymer material, or a plastic material.

3. The tool of claim 2, wherein the plastic is a thermoplastics, homopolymer acetal resin, polyethylene, high density polyethylene or ultra-high-molecular-weight polyethylene, acrylonitrile butadiene styrene (ABS), polyvinyl chloride (PVC).

4. The tool of claim 1, wherein the bottom support is a thermoplastics, homopolymer acetal resin, polyethylene, high density polyethylene or ultra-high-molecular-weight polyethylene.

5. The tool of claim 1 wherein bottom support is shaped or molded to cradle or hold a first corner of the medical device.

6. The tool of claim 1, wherein the top support is a thermoplastics, homopolymer acetal resin, polyethylene, high density polyethylene or ultra-high-molecular-weight polyethylene.

7. The tool of claim 1 wherein top support is shaped or molded to cradle or hold a second corner of the medical device.

8. The tool of claim 1, wherein the fixed hook subassembly comprises a hook, a stationary hook holder, and a stationary hook holder nest or platform.

9. The tool of claim 8, wherein the hook and stationary hook holder may be metal, polymer material or plastic material.

10. The tool of claim 8, wherein the stationary hook holder nest or platform may be a polymer material or plastic material.

11. The tool of claim 1, wherein the movable hook subassembly comprises a hook, a hook holder and a hook holder cap.

12. The tool of claim 11, wherein the hook is positioned on top of the hook holder and the hook holder cap is then position on top of the hook and hook holder.

13. The tool of claim 1, wherein the toggle clamp includes a toggle bar that can move around an axle or fulcrum, a U shaped bar with treaded ends, and a holder bar that is perpendicular to the toggle bar.

14. The tool of claim 13, wherein the holder bar comprises two openings on either side of the toggle bar in which the threaded ends of the U shaped bar are inserted and secured to the holder bar.

15. The tool of claim 1, wherein the bottom support, the top support, the fixed hook subassembly,
and the toggle clamp are attached to one side of the base support with a fastening means.

16. The tools of claim 15 wherein the fastening means comprise screws or screws with nuts.

17. A method of disassembling a medical device with the tool of claim 1 comprising the steps:
a. align a first access hole on a first side of a rear case of the medical device with the fixed hook so that the tip of the fixed hook enters the first access hole;
b. allow the medical device to rest on the bottom support, top support and base support;
c. position the toggle clamp and movable hook subassembly so that the tip of the movable hook enters a second access hole on an opposite side the rear case of the medical device;
d. rotate the toggle bar of the toggle clamp towards the base support and away from the medical device until it locks in place; and
e. remove a front case from the rear case of the medical device.
